(19) United States
(12) Patent Application Publication
(10) Pub. No.: US 2013/0278603 A1
(43) Pub. Date: Oct. 24, 2013

(54) Method, Electronic Device, And Computer Readable Medium For Distorting An Image On A Touch Screen

(71) Applicant: Tuming You, Xiamen (CN)

(72) Inventor: Tuming You, Xiamen (CN)

(21) Appl. No.: 13/452,763

(22) Filed: Apr. 20, 2012

(51) Int. Cl. G06F 3/041

(52) U.S. Cl. 345/428

(57) ABSTRACT

A method and apparatus for image distortion involves detection of finger motion on or near a touch screen and displaying a changed image on the touch screen. The changed image is a distortion of the initial image, and the distortion is defined by the movement path. The changed image can be constructed on condition that the movement path satisfies criteria, such as the movement path intersecting a boundary of the initial image and a start point of the movement path being substantially a corner of the initial image.

### FIELD OF THE INVENTION

This invention relates generally to graphic display and, more particularly, a method, electronic device, and computer readable medium for distorting an image on a touch touch-sensitive screen.

### BACKGROUND OF THE INVENTION

With the growing popularity of portable electronic devices, there are increasing demands placed by consumers on the functionality of portable electronic devices. In response to such demands, touch sensitive displays screens have been developed. With finger taps and movements on the touch sensitive display screen, users are able to interact with portable electronic devices without a conventional push-button keyboard and mouse input device. The phrases “touch sensitive display screen,” “touch sensitive screen,” and “touch screen” are used interchangeably herein.

Most common portable electronic devices, such as smart phones and tablet personal computers have applications for viewing images and browsing documents. Operations such as panning, pushing, and rotating images and text are accomplished by various finger gestures or motions over the touch screen.

Distortion of an image can be a useful function in many applications, such as 3D image rendering, mapping, image viewing, gaming, and entertainment. What is needed is a convenient and efficient way for a user to distort an image using one or more types of motions over a touch screen.

### SUMMARY OF THE INVENTION

Briefly and in general terms, the present invention is directed to image distortion on a touch screen. In aspects of the invention, a method comprises displaying an initial image on a touch screen of an electronic device, detecting a movement path of at least one object in contact with the touch screen, the detecting performed by the electronic device, and displaying a changed image on the touch screen, the changed image being a distortion of the initial image, the distortion corresponding to the movement path.

In other aspects of the invention, the initial image is planar and the distortion of the initial image provides a three-dimensional warped appearance to the changed image in comparison to the initial image.

In aspects of the invention, an electronic device comprises a memory device storing image data, a touch screen, and a processor in signal communication with the touch screen and the memory device. The processor is configured to execute instructions to display on the touch screen an initial image based on the image data, and execute instructions to detect a movement path of at least one object in contact with the touch screen, execute instructions to display a changed image on the touch screen. The changed image is a distortion of the initial image. The distortion corresponds to the movement path.

In other aspects, the instructions to display the changed imaged includes constructing the changed image according to any one or both of a first set of instructions and a second set of instructions. The first set of instructions includes instructions to place elements of the initial image closer to or further apart from each other. The second set of instructions includes instructions to move elements of the initial image according to a distance between a boundary of the initial image and corresponding points on the movement path.

In aspects of the present invention, a non-transitory computer readable medium has a stored computer program embodying instructions, which when executed by a computer, causes the computer to drive a touch screen. The computer readable medium comprises instructions to display on the touch screen an initial image, instructions to detect a movement path of at least one object in contact with the touch screen, instructions to display a changed image on the touch screen, the changed image being a distortion of the initial image, the distortion corresponding to the movement path.

The features and advantages of the invention will be more readily understood from the following detailed description which should be read in conjunction with the accompanying drawings.

### BRIEF DESCRIPTION OF THE DRAWINGS

FIG. 1 is a block diagram of an exemplary apparatus for displaying a three-dimensional image.

FIG. 2 is flow diagram of an exemplary method for distorting an image on a touch screen.

FIGS. 3-6 are diagrams of a touch screen showing in initial image, and a changed image constructed according to a movement path of a finger, or other object, in contact with the touch screen.

### DETAILED DESCRIPTION OF EXEMPLARY EMBODIMENTS

As used herein, any term of approximation such as, without limitation, near, about, approximately, substantially, essentially and the like mean that the word or phrase modified by the term of approximation need not be exactly that which is written but may vary from that written description to some extent. The extent to which the description may vary will depend on how great a change can be instituted and have one of ordinary skill in the art recognize the modified version as still having the properties, characteristics and capabilities of the modified word or phrase. For example and without limitation, a first element that is described as “substantially on” a second element encompasses a location that is perfectly on the second element and a location that one skilled in the art would readily recognize as being on the second element even though there small distance separates the first and second elements.

As used herein, the phrase “three-dimensional” in reference to an image means that the image has the appearance of depth, in addition to width and height, when displayed on a substantially flat surface.

As used herein, the word “distortion” in relation to an image refers to non-uniform modification of the image. Distortion of an image is distinct from uniform image scaling in which the same scaling factor is applied to all elements of the image. Distortion of an image is distinct from image panning in which all elements of the image are moved by the same distance. Distortion of an image is distinct from conventional image rotation in which the same rotation factor or angle is applied to all elements of the image in order to give the appearance of a different viewing angle without giving the appearance of shape deformation or warping. Unless specified otherwise, distortion of an image may include without limitation any one or a combination of (a) giving the appearance of shape deformation or warping, (b) shifting the position elements of the image by different distances in relation to original positions of the elements, (c) changing the displayed size of elements of the image according to different scale factors, and (d) mapping an image onto a three-dimensional surface.

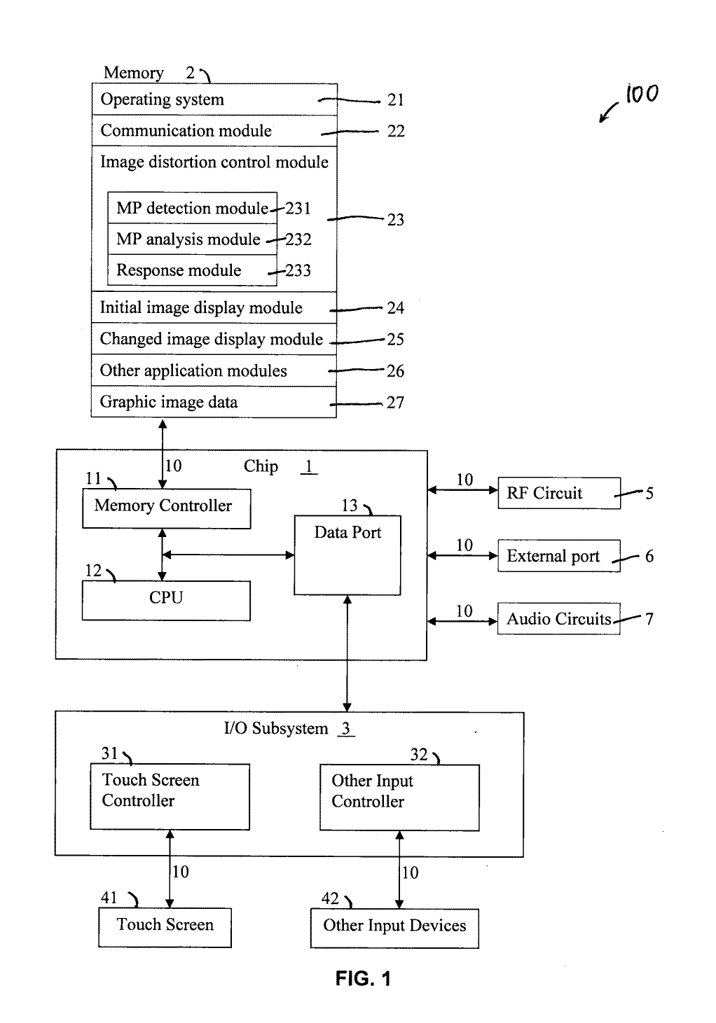

Referring now in more detail to the exemplary drawings for purposes of illustrating embodiments of the invention, wherein like reference numerals designate corresponding or like elements among the several views, there is shown in FIG. 1 an exemplary apparatus 100 for distorting an image displayed on touch-sensitive screen 41 of the apparatus.

Apparatus 100 can be a portable device such smart phone, electronic tablet, or personal digital assistant, personal computer, or apparatus 100 can be part of a large, non-portable system. A smart phone is a mobile phone built on a mobile computing platform that allows the smart phone to have, in addition to telecommunications, any one of a combination of features including without limitation a media player, digital camera, web browser, global positioning system navigation, Wi-Fi and other wireless data communication.

Other hardware configurations for apparatus 100 are within the scope of the invention.

Referring again to FIG. 1, apparatus 100 includes chip 1, memory 2 and input/output (I/O) subsystem 3. Chip 1 includes memory controller 11, processor (CPU) 12, and peripheral interface 13. Memory 2 is a single or multiple coupled volatile (transitory) and non-volatile (non-transitory) memory devices, including without limitation magnetic disk storage devices, flash memory devices, and other non-volatile solid-state memory. Software programs and image data are stored in memory 2. Software programs include operating system 21, communication module 22, image distortion control module 23, initial image display module 24, changed image display module 25, other application modules 26, and graphic image data 27. Image distortion control module 23 includes object movement path (MP) detection module 231, movement path analysis module 232, and response module 233. Any of the aforementioned modules and data can be stored in the volatile and/or non-volatile memory devices of memory 2.

I/O subsystem 3 includes touch screen controller 31 and other input controller 32. Chip 1 is connected to the RF circuit 5, external interface 6 and audio circuit 7. I/O subsystem 3 is connected to touch screen 41 and other input devices 42. Connections through signal bus 10 allow each of the above components to communicate with each other through any combination of a physical electrical connection and a wireless communication connection.

In alternative embodiments, any one or a combination of memory controller 11, processor 12, and peripheral interface 13 can be implemented in multiple, separate chips instead of a single chip. In some embodiments, some or all of memory 2 can be implemented on a single chip with any one or a combination of memory controller 11, processor 12, and peripheral interface 13.

Touch screen 41 is an electronic visual display configured to detect the presence, location, and movement of a physical object within the display area of the touch screen 41. The display area is that part of the touch screen 41 on which images are shown. The physical object can be a finger, a stylus, or other utensil manipulated by a person using apparatus 100. Object detection can be performed according to various technologies. Object detection can be accomplished with resistive, acoustic, infrared, near-infrared, vibratory, optical, surface capacitance, projected capacitance, mutual capacitance, and self-capacitance screen technologies. For example, detecting the presence, location, and movement of a physical object within the display area can include sensing a distortion of an electrostatic field of the screen, measurable as a change in capacitance due to physical contact with a finger or other electrical conductor. As a further example, object detection can include sensing disruption of a pattern or grid of electromagnetic beams without any need for actual physical contact with or touching of the display area.

Memory 2 stores three-dimensional image data 25 used to display a three-dimensional image on touch screen 41. Three-dimensional image display module 24 controls the display of the three-dimensional image on touch screen 41. Three-dimensional image rotation control module 23 includes a touch detection module 231 and touch response module 232. Touch detection module 231 includes instructions for detecting the presence, location, and movement of a physical object within the display area of touch screen 41. Touch response module 232 includes instructions for making one or more images or an animation of the three-dimensional image showing rotation of the image subject in response to a detection made by processor 12 in conjunction with touch detection module 231. Processor 12 includes one or more processors configured to execute the instructions for the above-described functions. Any one or a combination of the instructions for the above-described functions may be stored in a non-volatile (non-transitory) computer readable storage medium or a random access (transitory) computer readable storage medium of memory 2 accessible for execution by processor 12.

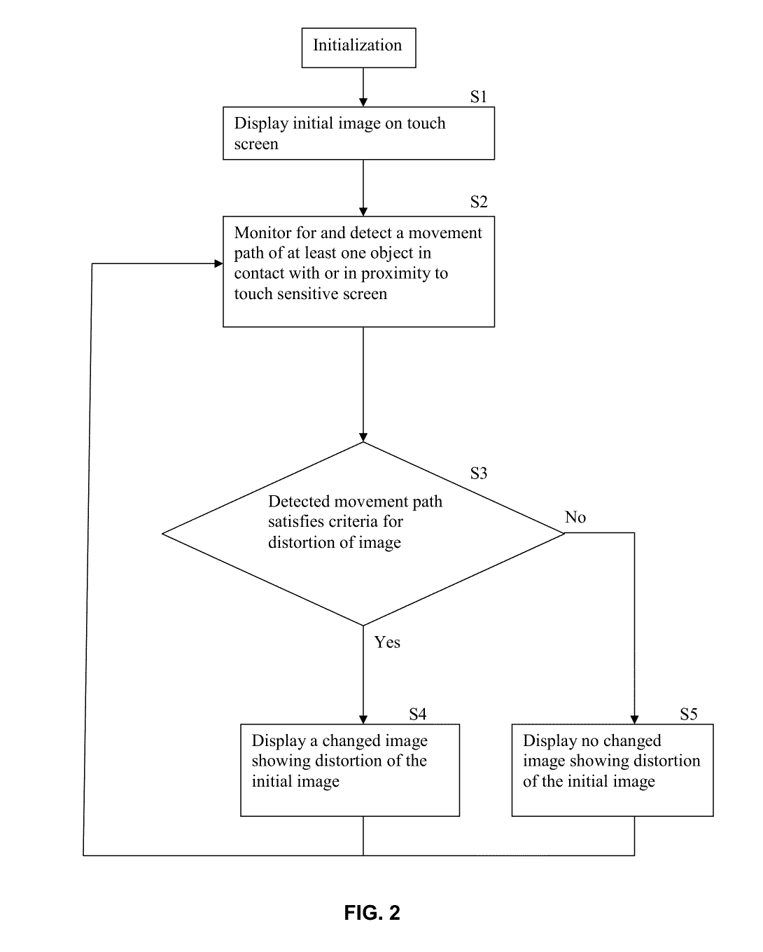

FIG. 2 shows a flow diagram of an exemplary method for distorting an image. Although the exemplary method is described in connection with apparatus 100 of FIG. 1, it will be appreciated that other devices may be used implement the method.

After initialization, processor 12 executes instructions, which may optionally be stored in non-volatile and/or random access computer readable storage media of memory 2, to allow apparatus 100 to perform the following functions. An initial image is displayed on touch screen 41 (block S1). The initial image can be a photographic image, or other type of image, based on graphic image data 27 optionally stored in non-volatile or volatile storage media of memory 2. Next, apparatus 100 monitors for and detects a movement path (block S2) of an object in contact with the display area of touch screen 41. Detection can be performed by processor 12 according to instructions in movement path detection module 231. Next, apparatus 100 determines whether the detected movement path satisfies any one or a combination of criteria for distortion of the initial image. The criteria, discussed below, are optionally stored in non-volatile or volatile storage media of memory 2, for distortion of the initial image. The determination of satisfying the criteria and the subsequent response can be performed by processor 12 according to instructions in movement analysis module 232 and response module 233.

Referring to block S3, if one or a combination of the criteria for distortion is met, the apparatus 100 displays a changed image on touch screen 41 (block S4). The changed image is based on the initial image. In some embodiments, the initial image is planar and the distortion of the initial image provides a three-dimensional warped appearance to the changed image in comparison to the initial image. The constructing and displaying of the changed image can be performed by processor 12 according to instructions in response module 233 and changed image display module 25, respectively.

In some embodiments, the distortion includes any one or any combination of (a) giving the appearance of shape deformation or warping, (b) shifting the position elements of the image by different distances in relation to original positions of the elements, (c) changing the displayed size of elements of the image according to different scale factors, and (d) mapping an image onto a three-dimensional surface.

Referring to block S3, if the criteria for distortion is not met, the apparatus 100 does not display a changed image showing distortion of the initial image on touch screen 41 (block S5). In some embodiments, apparatus 100 continues to display the initial image on touch screen 41. In other embodiments, when the detected movement path satisfies other criteria—such as for panning, uniform scaling, or conventional image rotation—apparatus 100 displays a changed image showing panning without distortion, uniform scaling (zoom in or zoom out) without distortion, or conventional image rotation without distortion.

In some embodiments, after block S4 and block 55, the apparatus 100 resumes by returning to block S2, to monitor and detect another movement path of an object in contact with the display area of touch screen 41.

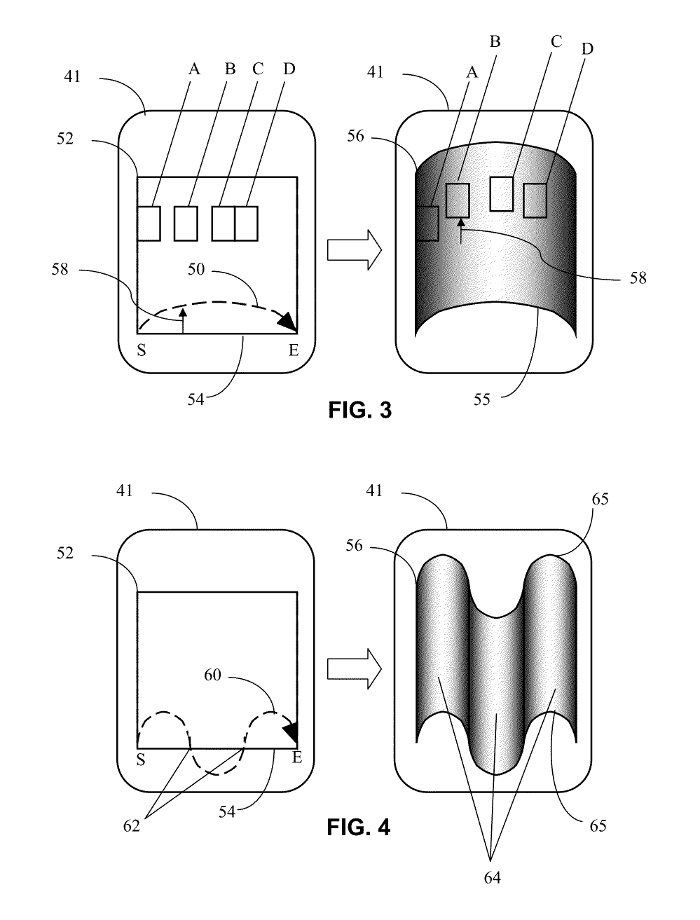

FIG. 3 shows exemplary movement path 50 (illustrated in broken line) of an object in contact with touch screen 41 on which initial image 52 is displayed. Movement path 50 is a continuous arc from start point S to end point E. Start point E and end point E are substantially on boundary 54 of initial image 52. More specifically, start point S and end point E are substantially on bottom corners of boundary 54. The arc of movement path can be a segment of a circle, a parabolic curve, or other type of curve.

When apparatus 100 determines that movement path 50 meets the criteria for distortion, apparatus 100 displays changed image 56 on touch screen 41. Changed image 56 replaces initial image 52 on touch screen 41. Initial image 52 includes image elements A, B, C, and D. The image elements represent parts of the image. The image elements may include one or a plurality of pixels. Changed image 56 has the same image elements. The position of the image elements in changed image 56 are different than the positions in initial image 52. In changed image 56, each of image elements A, B, C, and D has been moved by a distance 58, along the vertical axis, corresponding to a distance between a point on movement path 58 and image boundary 54. The distance 58 may be different for each of image elements A, B, C, and D. Movement in the direction of distance 58 is referred to as translational distortion. In FIG. 3, translational distortion is in the vertical direction or axis.

Also in changed image 56, a first group of image elements (A and B) are placed closer together, along the horizontal axis, as compared to their position in initial image 52. In changed image 56, a second group of image elements (C and D) are placed further apart from each other, along the horizontal axis, as compared to their position in initial image 52. Such movement can give changed image 56 the appearance of compression, expansion, or a combination of compression and expansion of initial image 52. Movement for placing image elements closer to and further apart from each other is referred to as compression-expansion distortion. In FIG. 3, compression-expansion distortion is in the horizontal direction.

It will be appreciated that the distortion can be accomplished in other directions. For example, FIG. 3 can be modified such that movement path 58 intersects the left side of boundary 54 so starting point S is at the top left corner of boundary 54 and end point E is at the bottom left corner of boundary 54. Translational distortion would be in the horizontal direction, and compression-expansion distortion would be in the vertical direction substantially perpendicular to the horizontal direction.

In some embodiments, movement path 54 results in translational distortion without compression-expansion distortion. In alternative embodiments, movement path 54 results in compression-expansion distortion without translational distortion.

In some embodiments, the shape of movement path 54 defines, at least in part, the shape of boundary 55 of changed image 56. In FIG. 3, the top side and bottom side of boundary 55 of changed image 56 is the same as the shape of movement path 54 on initial image 52.

FIG. 4 shows exemplary movement path 60 (illustrated in broken line). Movement path 60 is continuous from start point S to end point E. Movement path 60 intersects the bottom side of boundary 54 at the two bottom corners of boundary 54 and at two points between the bottom corners. Movement path 60 has three curvilinear segments connected to one another at inflection points 62 on movement path 60. When apparatus 100 determines that movement path 60 meets the criteria for distortion, initial image 52 is distorted according to each of the curvilinear segments to construct changed image 56.

In some embodiments, initial image 52 is mapped onto one or more three-dimensional cylindrical surfaces. In FIG. 4, initial image 52 is mapped onto three three-dimensional cylindrical surfaces 64. Each cylindrical surface 64 has a shape defined at least in part by the corresponding curvilinear segment of movement path 62. The top and bottom edges 65 of the cylindrical surfaces have substantially the same shape as movement path 60. In changed image 56, each cylindrical surface 64 shows any one or both of translation distortion and compression-expansion distortion.

In other embodiments, movement path 60 intersects the left side, top side, or right side of boundary 54, and results in any or both of translation distortion and compression-expansion distortion in different directions.

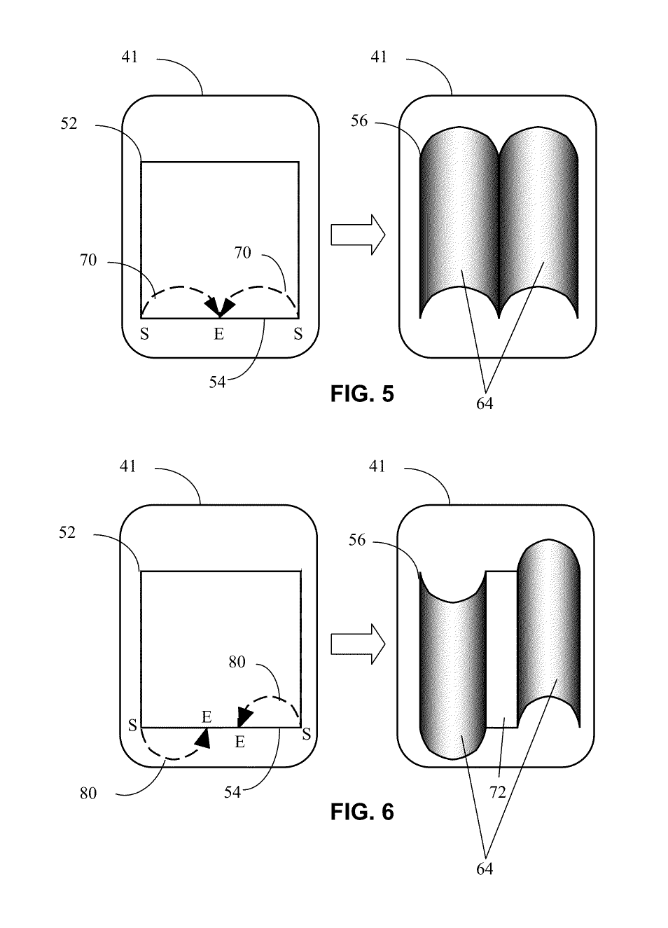

FIG. 5 shows exemplary movement path 70 (illustrated in broken line) of two objects in contact with touch screen 41. Each object starts (start point S) at a bottom corner of boundary 54 and traces an arc that ends (end point E) between the two corners. Each object ends at substantially the same end point E. Movement path 70 has two curvilinear segments, each defined by one of the objects. The curvilinear segments are connected to one another at a discontinuity point corresponding to the common endpoint E of the two objects. When apparatus 100 determines that movement path 60 meets the criteria for distortion, changed image 56 is constructed by apparatus 100 and displayed on touch screen 41. Changed image 56 has two three-dimensional cylindrical surfaces 64, each corresponding to one of the curvilinear segments of movement path 70 on initial image 52. In changed image 56, each cylindrical surface 64 shows any one or both of translation distortion and compression-expansion distortion.

In other embodiments, movement path 70 intersects the left side, top side, or right side of boundary 54, and results in any or both of translation distortion and compression-expansion distortion in different directions.

FIG. 6 shows exemplary movement path 70 (illustrated in broken line) of two objects in contact with touch screen 41. Each object starts (start point S) at a bottom corner of boundary 54 and traces a continuous arc that ends at different points (end point E) between the two corners. Movement path 80 has two curvilinear segments that do not meet. When apparatus 100 determines that movement path 80 meets the criteria for distortion, changed image 56 is constructed by apparatus 100 and displayed on touch screen 41. Changed image 56 has two three-dimensional cylindrical surfaces 64, each corresponding to one of the curvilinear segments of movement path 80 on initial image 52. Cylindrical surfaces 64 are connected to each other by image strip 72. In changed image 56, each cylindrical surface 64 shows any one or both of translation distortion and compression-expansion distortion. Image strip 72 shows an unchanged strip of initial image 52 between movement path end points E.

In other embodiments, movement path 80 intersects the left side, top side, or right side of boundary 54, and results in any or both of translation distortion and compression-expansion distortion in different directions.

As indicated above, changed image 56 is displayed when CPU 12 of apparatus 100 determines that the movement path satisfies criteria for distortion. The criteria for distortion can be based on boundary 54 of initial image 52. The criteria for distortion can include any one or any combination of (a) a requirement that the movement path intersects a boundary of the initial image, (b) a requirement that any one or both of a start point and an end point of the movement path are located substantially on a boundary of the initial image, (c) a requirement that any one or both of a start point and an end point of the movement path are located substantially on a corner of the initial image, and (d) a requirement that a curvature measurement of the movement path is one or both of above a minimum curvature limit and below a maximum curvature limit.

It will be appreciated that the above described method embodiments and associated processor executed instructions can be performed without contacting a touch screen configured to detect proximity of an object, such as by using a grid of electromagnetic beams arranged in front of the touch screen display area.

It will be appreciated that the present invention provides convenient finger or stylus movements to apply distortion to an image on a touch screen without the use of conventional keyboards, wheels, tracking balls, and mouse pointers. The present invention can thus greatly expand the functionality of smart phones, tablet PCs, other portable electronic devices to include graphics editing and mapping applications.

While several particular forms of the invention have been illustrated and described, it will also be apparent that various modifications can be made without departing from the scope of the invention. It is also contemplated that various combinations or subcombinations of the specific features and aspects of the disclosed embodiments can be combined with or substituted for one another in order to form varying modes of the invention. Accordingly, it is not intended that the invention be limited, except as by the appended claims.

What is claimed is:

1. A method of distorting an image, the method comprising:
displaying an initial image on a touch screen of an electronic device;
detecting a movement path of at least one object in contact with the touch screen, the detecting performed by the electronic device; and
displaying a changed image on the touch screen, the changed image being a distortion of the initial image, the distortion corresponding to the movement path.

2. The method of claim 1, wherein the initial image is planar and the distortion of the initial image provides a three-dimensional warped appearance to the changed image in comparison to the initial image.

3. The method of claim 1, wherein the displaying of the changed image includes constructing the changed image by placing a first group of elements of the initial image closer to each other in the changed image, and placing a second group of elements of the initial image further part from each other in the changed image.

4. The method of claim 1, wherein the displaying of the changed image includes constructing the changed image by moving an element of the initial image by a distance substantially equal to a distance between a corresponding point on the movement path and a boundary of the initial image.

5. The method of claim 1, wherein the displaying of the changed image includes constructing the changed image by placing elements of the initial image closer to or further apart from each other along a first axis, and moving the elements along a second axis according to a distance between a boundary of the initial image and corresponding points on the movement path, wherein the second axis is substantially perpendicular to the first axis.

6. The method of claim 1, wherein the detecting of the movement path includes detecting an arc defined by the movement path, and the displaying of the changed image includes distorting the initial image according to the arc.

7. The method of claim 1, wherein the displaying of the changed image includes mapping the initial image to a three-dimensional cylindrical surface having a shape defined at least in part by the movement path.

8. The method of claim 7, wherein the detecting of the movement path includes detecting an arc defined by the movement path, and the shape of the three-dimensional cylindrical surface is defined at least in part by the arc.

9. The method of claim 1, wherein the detecting of the movement path includes detecting at least two curvilinear segments, each segment connected to another one of the segments at an inflection point or discontinuity point, and the displaying of the changed image includes distorting the initial image according to each of the curvilinear segments.

10. The method of claim 9, wherein the least two curvilinear segments are defined by continuous movement of a single object in contact with the touch screen.

11. The method of claim 9, wherein one of the curvilinear segments is defined by movement of one object in contact with the touch screen, and another one of the curvilinear segments is defined movement of another object in contact with the touch screen.

12. The method of claim 1, wherein the displaying of the changed image includes mapping the initial image to a plurality of three-dimensional cylindrical surfaces, and each three-dimensional cylindrical surface has a shape defined at least in part by a corresponding segment of the movement path.

13. The method of claim 12, wherein the detecting of the movement path includes detecting a curve defined by the movement path, the curve having at least two segments, and the cylindrical surfaces are defined by respective segments of the curve.

14. The method of claim 1, further comprising the electronic device determining that the movement path satisfies criteria, and wherein the displaying of the changed image is performed on condition that the movement path satisfies the criteria.

15. The method of claim 14, wherein the criteria is based on a boundary of the initial image.

16. The method of claim 14, wherein the criteria includes a requirement selected from the group consisting of a requirement that the movement path intersects a boundary of the initial image, a requirement that any one or both of a start point and an end point of the movement path are located substantially on a boundary of the initial image, a requirement that any one or both of a start point and an end point of the movement path are located substantially on a corner of the initial image, and a requirement that a curvature measurement of the movement path is, either or both, above a minimum curvature limit and below a maximum curvature limit.

17. An electronic device for distorting an image, the electronic device comprising:
a memory device storing image data;
a touch screen; and
a processor in signal communication with the touch screen and the memory device, the processor configured to execute instructions to display on the touch screen an initial image based on the image data, and execute instructions to detect a movement path of at least one object in contact with the touch screen, execute instructions to display a changed image on the touch screen, the changed image being a distortion of the initial image, the distortion corresponding to the movement path.

18. The method of claim 17, wherein the instructions to display the changed imaged includes constructing the changed image according to any one or both of a first set of instructions and a second set of instructions,
wherein the first set of instructions includes instructions to place elements of the initial image closer to or further apart from each other, and
wherein the second set of instructions includes instructions to move elements of the initial image according to a distance between a boundary of the initial image and corresponding points on the movement path.

19. The method of claim 17, wherein the memory device includes at least one non-volatile memory element, and the at least one non-volatile memory element stores any one or a combination of:
the instructions to display on the touch screen the initial image,
the instructions to detect the movement path of the at least on object, and
the instructions to display the changed image on the touch screen.

20. A non-transitory computer readable medium having a stored computer program embodying instructions, which when executed by a computer, causes the computer to drive a touch screen, the computer readable medium comprising:
instructions to display on the touch screen an initial image;
instructions to detect a movement path of at least one object in contact with the touch screen;
instructions to display a changed image on the touch screen, the changed image being a distortion of the initial image, the distortion corresponding to the movement path.

21. The computer readable medium of claim 20, wherein the instructions to display the changed image includes instructions to construct the changed image according to any one or both of a first set of instructions and a second set of instructions,
wherein the first set of instructions includes instructions to place elements of the initial image closer to or further apart from each other, and
wherein the second set of instructions includes instructions to move elements of the initial image according to a distance between a boundary of the initial image and corresponding points on the movement path.
